(19) United States
(12) Patent Application Publication
(10) Pub. No.: US 2016/0146423 A1
(43) Pub. Date: May 26, 2016

(54) VEHICLE LIGHTING DEVICE

(71) Applicant: Coretronic Corporation, Hsin-Chu (TW)

(72) Inventors: JYUN-LIN LAI, Hsin-Chu (TW); TZU-TSE HUANG, Hsin-Chu (TW); CHAO-NAN CHIEN, Hsin-Chu (TW)

(21) Appl. No.: 14/746,374

(22) Filed: Jun. 22, 2015

(30) Foreign Application Priority Data
Nov. 26, 2014 (TW) 103140915

(51) Int. Cl. F21S 8/10

(52) U.S. Cl. CPC F21S 48/328; F21S 48/115; F21S 48/1225

(57) ABSTRACT

A vehicle lighting device includes a lens unit, a lighting unit and an adhesive. The lens unit includes a lens holder and at least one lens disposed inside the lens holder, and the lens holder has at least one pillar portion. The lighting unit includes a base and a lighting element fixed on the base. The base has a center portion abutting against the lighting element and a peripheral portion outside the center portion, the peripheral portion has at least one first hole, the pillar portion is inserted in the first hole to connect the lens unit with the lighting unit, and the pillar portion and the peripheral portion are made of the same material. The adhesive adheres the pillar portion to the peripheral portion to fix the lens in a predetermined position relative to the lighting element.

### BACKGROUND OF THE INVENTION

a. Field of the Invention

The invention relates generally to a lighting device, and, more particularly, to a vehicle lighting device having improved optical efficiency.

b. Description of the Related Art

Nowadays, halogen bulbs serving as light sources are widely used in vehicle headlamps. However, halogen bulbs generally have unsatisfactory luminous efficacy and short operational life, and thus a current trend is to use light-emitting diodes with improved luminous efficacy and long operational life as light sources for vehicle headlamps. Normally, light-emitting diodes need to operate at lower temperatures to elongate their operational life. However, similar to a conventional method for encapsulating halogen bulbs in a vehicle headlamp, light-emitting diodes and a heat sink are encapsulated altogether in a lamp housing of a vehicle headlamp. As such, it may not be easily to dissipate heat in a vehicle headlamp using light-emitting diodes as light sources.

Taiwan utility model patent No. M482521 discloses a vehicle lamp structure having an illumination unit, a heat-dissipation unit and a waterproof sleeve. The illumination unit includes a mount, a lens and a light-emitting element. The heat-dissipation unit includes a heat-dissipation chassis and a heat-dissipation cover, and the waterproof sleeve has a first part and a second part. Taiwan utility model patent No. M388602 discloses a lens positioning mechanism, where a lens has a positioning pillar, a light-emitting element has a positioning hole, and the positioning pillar is inserted in the positioning hole. Taiwan patent No. I442595 discloses a light-emitting diode device, where a substrate and a lead frame are disposed on a base, and heat generated by a light-emitting diode chip is transferred to the base via the substrate and through heat conduction.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention was acknowledged by a person of ordinary skill in the art.

### BRIEF SUMMARY OF THE INVENTION

The invention provides a vehicle lighting device having improved heat-dissipation efficiency and optical efficiency.

Other objects and advantages of the invention can be further illustrated by the technical features broadly embodied and described as follows.

In order to achieve one or a portion of or all of the objects or other objects, one embodiment of the invention provides an vehicle lighting device including a lens unit, a lighting unit and an adhesive. The lens unit includes a lens holder and at least one lens disposed inside the lens holder, and the lens holder has at least one pillar portion. The lighting unit includes a base and a lighting element fixed on the base. The base has a center portion abutting against the lighting element and a peripheral portion outside the center portion, the peripheral portion has at least one first hole, the pillar portion is inserted in the first hole to connect the lens unit with the lighting unit, and the pillar portion and the peripheral portion are made of the same material. The adhesive adheres the pillar portion to the peripheral portion to fix the lens in a predetermined position relative to the lighting element.

In one embodiment, the center portion and the peripheral portion of the base are made of different materials, and a heat conduction coefficient of the center portion is larger than a heat conduction coefficient of the peripheral portion. The center portion may be made of metal and the peripheral portion may be made of plastic.

In one embodiment, the center portion has a heat sink extending in a direction facing away from the lighting unit.

In one embodiment, a heat sink is disposed on one side of the lighting unit and contacts the center portion of the base.

In one embodiment, the peripheral portion has at least one second hole, and the heat sink is attached to one side of the lighting unit facing away from the lens unit via the second hole.

In one embodiment, the lighting element includes an Al-base printed circuit board and at least one light-emitting diode chip, and the Al-base printed circuit board contacts the center portion of the base.

In one embodiment, the Al-base printed circuit board of the lighting element is secured to the center portion of the base through at least one screw.

In one embodiment, the center portion of the base is in the form of an opening, and the lighting element is inserted in the opening

In one embodiment, the Al-base printed circuit board of the lighting element abuts against a side wall of the opening and contacts the heat sink.

In one embodiment, the adhesive comprises glue.

In one embodiment, a clearance space is formed between the pillar portion and the first hole, and a light beam emitted by the lighting element passes through the lens in the predetermined position to form a light pattern.

According to the above embodiments, when the lens unit and the lighting unit are aligned and connected with each other, the pillar portion of the lens holder is inserted in the first hole of the base, and a clearance space is formed between the pillar portion and the first hole to allow the lens to move to a predetermined position relative to the lighting element and thus form a light pattern with improved optical efficiency. When the lens is located in the predetermined position, an adhesive is disposed in the first hole to adhere the pillar portion to the peripheral portion to fix the lens in the predetermined position relative to the lighting element, therefore preventing variations in the output light pattern as a result of vibration. Further, the pillar portion of the lens holder and the peripheral portion of the base may be made of the same material to enhance the adhesion between the pillar portion and the base. Moreover, in case the center portion and the peripheral portion of the base are made of different materials, heat generated by the lighting element that abuts against the center portion having a high heat conduction coefficient can be quickly transferred to the center portion and absorbed by the heat sink to effectively dissipate heat.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows an exploded view of a vehicle lighting device according to an embodiment of the invention.

FIG. 2 shows a perspective view of an assembled vehicle lighting device.

FIG. 3 is a schematic cross-section of the vehicle lighting device shown in FIG. 2.

FIG. 4 shows an exploded view of a lighting unit according to an embodiment of the invention.

FIG. 5 shows an exploded view of a lighting unit according to another embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

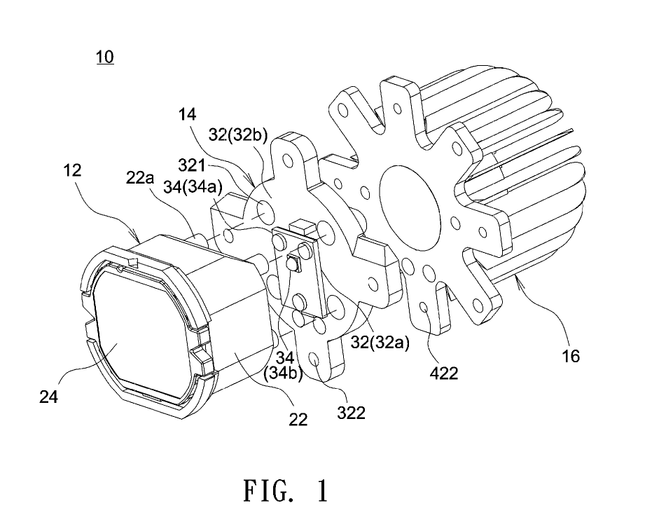

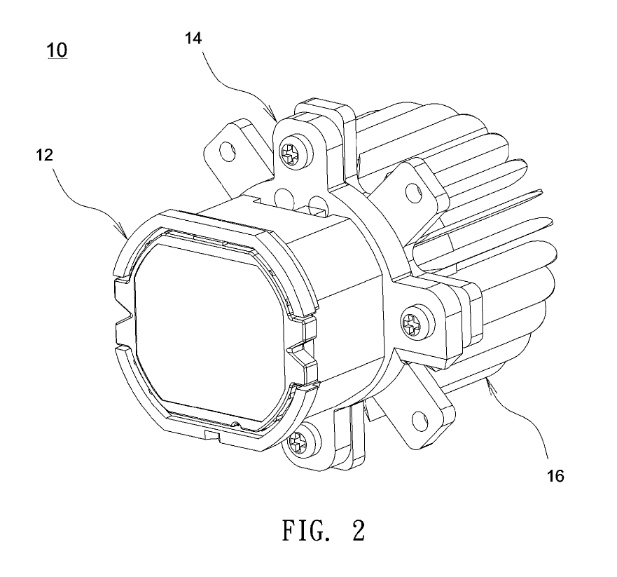

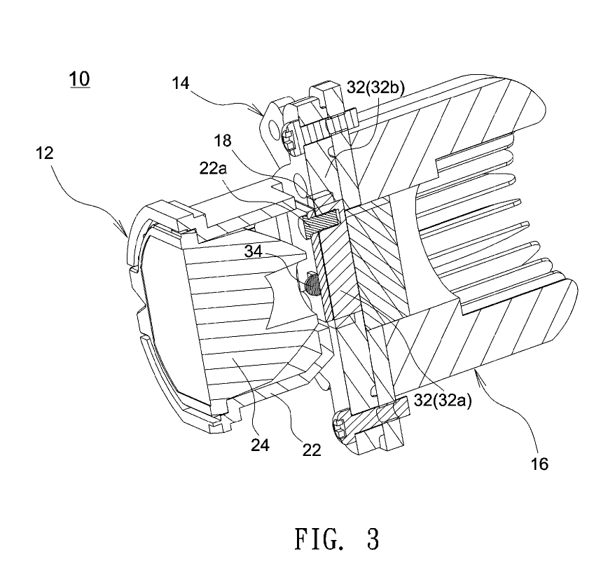

FIG. 1 shows an exploded view of a vehicle lighting device according to an embodiment of the invention, FIG. 2 shows a perspective view of an assembled vehicle lighting device, and FIG. 3 is a schematic cross-section of the vehicle lighting device shown in FIG. 2. As illustrated in FIG. 1 to FIG. 3, a vehicle lighting device 10 includes a lens unit 12 and a lighting unit 14. The lens unit 12 includes a lens holder 22 and a lens 24 disposed inside the lens holder 22. Alternatively, the lens holder 22 may receive multiple lenses 24 not limited to a particular number, and the lens number can be determined according to desired optical effects. The lens holder 22 has at least one pillar portion 22a. The lighting unit 14 includes a base 32 and a lighting element 34 fixed on the base 32. The base 32 has a center portion 32a abutting against the lighting element 34 and a peripheral portion 32b outside the center portion 32a. The peripheral portion 32b may have at least one first hole 321. A heat sink 16 may be disposed on one side of the lighting unit 14 and may contact the center portion 32a of the base 32. In this embodiment, the peripheral portion 32b substantially surrounds the center portion 32a and has multiple first holes 321 separated from each other. The pillar portion 22a is inserted in the first hole 321 to align and connect the lens unit 12 with the lighting unit 14, where a clearance space is formed between the pillar portion 22a and the first hole 321. Therefore, the position of the lens unit 12 may be finely adjusted through the clearance space to allow the lens 24 to move to a predetermined position relative to the lighting element 34. Under the circumstance, a light beam emitted by the lighting element 34 and passing through the lens 24 located in the predetermined position is allowed to form a light pattern having improved optical efficiency and conforming to specific standards. Further, as shown in FIG. 3, the pillar portion 22a is adhered to the peripheral portion 32b through an adhesive 18 such as glue to fix the lens 24 in the predetermined position relative to the lighting element 34, therefore preventing variations in the output light pattern as a result of vibration. In this embodiment, the pillar portion 22a of the lens holder 22 and the peripheral portion 32b having the first hole 321 may be made of the same material such as plastic to enhance the adhesion between the pillar portion 22a and the base 32.

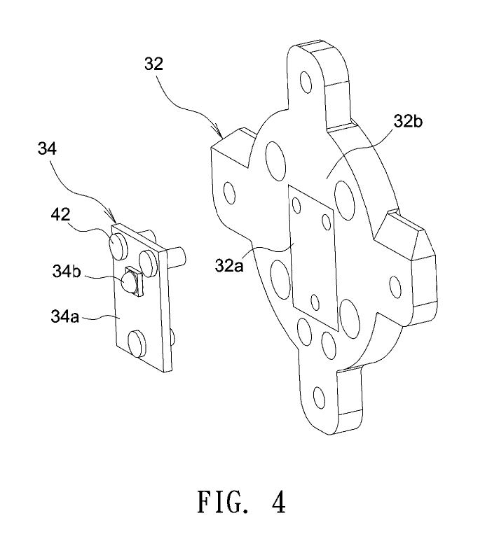

As shown in FIG. 4, in this embodiment, the center portion 32a and the peripheral portion 32b of the base 32 may be made of different materials. For example, the center portion 32a may be made of metal such as copper or aluminum having a high heat conduction coefficient, and the peripheral portion 32b may be made of plastic having a low heat conduction coefficient. Therefore, when the lighting element 34 abuts against the center portion 32a having a high heat conduction coefficient, heat generated by the lighting element 34 can be quickly transferred to the center portion 32a and absorbed by the heat sink 16 to effectively dissipate heat. Further, the pillar portion 22a of the lens holder 22 and the peripheral portion 32b of the base 32 may be made of the same material such as plastic to provide more rigid adhesion. In another embodiment, the center portion 32a and the peripheral portion 32b of the base 32 may be made of the same material, such as copper or aluminum having a high heat conduction coefficient. In one embodiment, the lighting element 34 may include an Al-base printed circuit board 34a and at least one light-emitting diode chip 34b. FIG. 4 only exemplarily shows one light-emitting diode chip 34b, but the invention is not limited to a particular number. In another embodiment, the light-emitting diode chip 34b may be replaced with another kind of solid state lighting unit. The Al-base printed circuit board 34a may cover an area substantially equal to an area of the center portion 32a, and the Al-base printed circuit board 34a may contact the center portion 32a of the base 32. In one embodiment, the Al-base printed circuit board 34a may be secured to the center portion 32a of the base 32 by at least one screw 42.

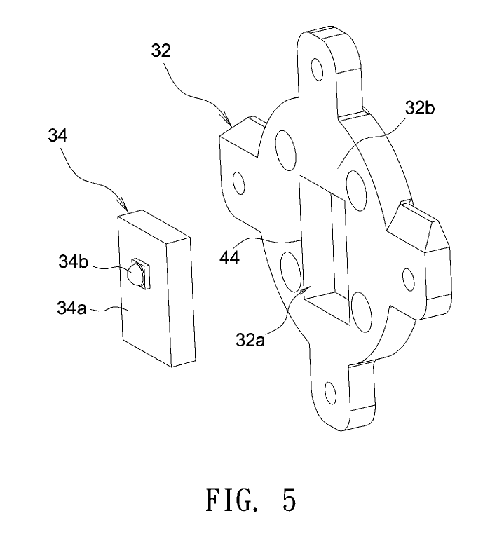

As shown in FIG. 5, in another embodiment, the center portion 32a of the base 32 is in the form of an opening, and the lighting element 34 is inserted in the opening to allow the Al-base printed circuit board 34a to abut against a side wall 44 of the opening and contact the heat sink 16. Because the center portion 32a of the base 32 corresponding to the Al-base printed circuit board 34a is hollowed out, the Al-base printed circuit board 34a may directly contact the heat sink 16 to quickly transfer heat to the heat sink 16.

Referring to FIG. 1 again, in one embodiment, the peripheral portion 32b of the base 32 is additionally provided with at least one second hole 322, and the heat sink 16 has at least one fastening hole 422 corresponding to the second hole 322. The heat sink 16 is secured to the second hole 322 of the lighting unit 14 via the fastening hole 422 by, for example, screws and attached to one side of the lighting unit 14 facing away from the lens unit 12. In an alternate embodiment, the center portion 32a of the base 32 may extend in a direction facing away from the lighting unit 14 to additionally form the heat sink 16.

According to the above embodiments, when the lens unit and the lighting unit are aligned and connected with each other, the pillar portion of the lens holder is inserted in the first hole of the base, and a clearance space is formed between the pillar portion and the first hole to allow the lens to move to a predetermined position relative to the lighting element and thus form a light pattern with improved optical efficiency. When the lens is located in the predetermined position, an adhesive is disposed in the first hole to adhere the pillar portion to the peripheral portion to fix the lens in the predetermined position relative to the lighting element, therefore preventing variations in the output light pattern as a result of vibration. Further, the pillar portion of the lens holder and the peripheral portion of the base may be made of the same material to enhance the adhesion between the pillar portion and the base. Moreover, in case the center portion and the peripheral portion of the base are made of different materials, heat generated by the lighting element that abuts against the center portion having a high heat conduction coefficient can be quickly transferred to the center portion and absorbed by the heat sink to effectively dissipate heat.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A vehicle lighting device, comprising:
a lens unit comprising a lens holder and at least one lens disposed inside the lens holder, wherein the lens holder has at least one pillar portion;
a lighting unit comprising a base and a lighting element fixed on the base, wherein the base has a center portion abutting against the lighting element and a peripheral portion outside the center portion, the peripheral portion has at least one first hole, the pillar portion is inserted in the first hole to connect the lens unit with the lighting unit, and the pillar portion and the peripheral portion are made of the same material; and
an adhesive for adhering the pillar portion to the peripheral portion to fix the lens in a predetermined position relative to the lighting element.

2. The vehicle lighting device as claimed in claim 1, wherein the center portion and the peripheral portion of the base are made of different materials, and a heat conduction coefficient of the center portion is larger than a heat conduction coefficient of the peripheral portion.

3. The vehicle lighting device as claimed in claim 2, wherein the center portion is made of metal and the peripheral portion is made of plastic.

4. The vehicle lighting device as claimed in claim 2, wherein the center portion comprises a heat sink extending in a direction facing away from the lighting unit.

5. The vehicle lighting device as claimed in claim 2, wherein the lighting element comprises an Al-base printed circuit board and at least one light-emitting diode chip, and the Al-base printed circuit board contacts the center portion of the base.

6. The vehicle lighting device as claimed in claim 5, further comprising:
at least one screw for securing the Al-base printed circuit board to the center portion of the base.

7. The vehicle lighting device as claimed in claim 1, further comprising:
a heat sink disposed on one side of the lighting unit and contacting the center portion of the base.

8. The vehicle lighting device as claimed in claim 7, wherein the peripheral portion has at least one second hole, and the heat sink is attached to one side of the lighting unit facing away from the lens unit via the second hole.

9. The vehicle lighting device as claimed in claim 1, wherein the center portion of the base is in the form of an opening, and the lighting element is inserted in the opening.

10. The vehicle lighting device as claimed in claim 9, wherein the lighting element comprises an Al-base printed circuit board and at least one light-emitting diode chip, and the Al-base printed circuit board abuts against a side wall of the opening.

11. The vehicle lighting device as claimed in claim 10, further comprising:
a heat sink disposed on one side of the lighting unit and contacting the Al-base printed circuit board.

12. The vehicle lighting device as claimed in claim 1, wherein the adhesive comprises glue.

13. The vehicle lighting device as claimed in claim 1, wherein a clearance space is formed between the pillar portion and the first hole, and a light beam emitted by the lighting element passes through the lens in the predetermined position to form a light pattern.
